(19) United States
(12) Patent Application Publication
(10) Pub. No.: US 2014/0334147 A1
(43) Pub. Date: Nov. 13, 2014

(54) LED BULB WITH A GAS MEDIUM HAVING A UNIFORM LIGHT-DISTRIBUTION PROFILE

(71) Applicant: Switch Bulb Company, Inc., San Jose, CA (US)

(72) Inventors: Matrika BHATTARAI, San Jose, CA (US); Ronan LE TOQUIN, Sunnyvale, CA (US); David HORN, Saratoga, CA (US)

(21) Appl. No.: 13/892,186

(22) Filed: May 10, 2013

(51) Int. Cl. F21K 99/00

(52) U.S. Cl. CPC F21K 9/10; F21K 9/90
USPC 362/235; 29/592.1; 362/249.02; 362/249.06

(57) ABSTRACT

An LED bulb includes a base, a shell, and a plurality of LEDs. The shell is connected to the base and the plurality of LEDs is disposed within the shell. The LEDs are configured to provide the LED bulb with a uniform light-distribution profile.

### BACKGROUND

1. Field

The present disclosure relates generally to light emitting diode (LED) bulbs and, more specifically, to an LED bulb with a gas medium having a uniform light-distribution profile.

2. Related Art

Traditionally, lighting has been generated using fluorescent and incandescent light bulbs. While both types of light bulbs have been reliably used, each suffers from certain drawbacks. For instance, incandescent bulbs tend to be inefficient, using only 2-3% of their power to produce light, while the remaining 97-98% of their power is lost as heat. Fluorescent bulbs, while more efficient than incandescent bulbs, do not produce the same warm light as that generated by incandescent bulbs. Additionally, there are health and environmental concerns regarding the mercury contained in traditional fluorescent bulbs.

Thus, an alternative light source is desired. One such alternative is a bulb utilizing an LED. An LED comprises a semiconductor junction that emits light due to an electrical current flowing through the junction. Compared to a traditional incandescent bulb, an LED bulb is capable of producing more light using the same amount of power. Additionally, the operational life of an LED bulb may be multiple orders of magnitude longer than that of an incandescent bulb, for example, 10,000-100,000 hours as opposed to 1,000-2,000 hours.

The quality of the light produced by an LED bulb may be compared to a traditional incandescent bulb, which produces a relatively uniform light distribution profile using a filament element. Thus, it may be advantageous for an LED bulb to have a uniform light-distribution profile over a substantial portion of the bulb surface. For example, portions of the Energy Star light-distribution specification states that the light intensity emissions of a light bulb should not vary greater than 20 percent over an area from 0 degrees to 135 degrees, as measured from an axis through the center of the bulb through the apex of the bulb. One challenge to producing a bulb using LEDs is that the light distribution is not inherently uniform, as stated in relevant portions of the Energy Star specifications.

The devices and methods described herein can be used to produce an LED bulb with a light-distribution profile having improved uniformity of light distribution. In several embodiments, LED bulbs are provided that produce lighting uniformity that meets Energy Star specifications for light-distribution profile uniformity.

### SUMMARY

One exemplary embodiment includes a light-emitting diode (LED) bulb. The LED bulb includes a base and a shell connected to the base. A plurality of LEDs is disposed within the shell. A first set of LEDs of the plurality of LEDs is positioned a first distance with respect to the center of a convex portion of the shell, and at a first angle with respect to a centerline of the LED bulb. A second set of LEDs of the plurality of LEDs is positioned a second distance with respect to the center of the convex portion of the shell, and at a second angle with respect to a centerline of the LED bulb. The LEDs and the shell are configured to provide the LED bulb with a predicted light-distribution profile that varies less than 20 percent in light intensity over 0 degrees to 135 degrees as measured from an axis from the center of the shell through an apex of the shell.

In some embodiments, the positions of the first and second sets of LEDs with respect to the shell are configured to provide the LED bulb with the predicted light-distribution profile. In some embodiments, the first distance, first angle, second distance, and second angle are configured to provide the LED bulb with the predicted light-distribution profile.

In one exemplary embodiment, the first distance ranges from 9 mm to 15 mm above the center of the convex portion of the shell and the second distance ranges from 1 mm below to 6.5 mm above the center of the convex portion of the shell. In one exemplary embodiment, the first angle ranges from 30 degrees to 40 degrees with respect to the centerline of the LED bulb and the second angle ranges from −15 degrees to −20 degrees with respect to the centerline of the LED bulb.

### DESCRIPTION OF THE FIGURES

FIGS. 1A-C depict an exemplary LED bulb.

FIG. 2 depicts a predicted light-distribution profile for an LED bulb.

FIG. 3A-B depict exemplary support structures for an LED bulb.

FIGS. 4A-B depict predicted light distribution uniformity data for an LED bulb.

FIGS. 5A-C depict predicted light distribution uniformity data for an LED bulb.

FIGS. 6A-B depict an exemplary LED bulb.

FIG. 7A depicts a predicted light-distribution profile for an LED bulb.

FIG. 7B depicts a measured light-distribution profiles for an LED bulb.

FIG. 8 depicts the diffusion profile for different shell materials.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

As previously mentioned, the energy efficiency of an LED bulb provides some inherent advantages over a traditional incandescent and compact fluorescent bulb. In some embodiments, an LED bulb may use 6 to 20 watts of electrical power to produce light equivalent to a 40 watt incandescent bulb. LED bulbs are also typically free of mercury and other potentially hazardous materials used in traditional compact fluorescent light bulbs.

One potential disadvantage to LED bulbs is that the distribution of light around the bulb does not inherently match light produced by a traditional incandescent light bulb. Specifically, a traditional incandescent light bulb produces a light emission using a heated filament, which produces a substantially uniform light intensity over a wide range of emission angles. In contrast, most commercial LEDs function as an area light source and emit light having an intensity that is approximately proportional to the cosine of angle of emission. In an ideal case, the emission profile of an LED may be characterized as a Lambertian emission profile. As a result, the light produced by an LED tends to be most intense in a direction substantially perpendicular to the light emitting area or face of the LED. Depending, in part, on the relative position of the LEDs in a bulb, the light distribution of an LED bulb may be non-uniform and characterized by brighter and darker regions over a wide range of emission angles.

Accordingly, as discussed above, it may be desirable to produce an LED bulb having a uniform light-distribution profile. More specifically, it may be desirable to produce an LED bulb that conforms to relevant portions of the Energy Star specification directed to LED lamps. Relevant portions of Section 7A of Energy Star Program states that qualifying LED bulbs shall have an even intensity distribution of luminous intensity (candelas) within the 0° to 135° zone (vertically axially symmetrical). Luminous intensity at any angle within this zone shall not differ from the mean luminous intensity for the entire 0 degrees to 135 degrees zone by more than 20%.

Due to emission characteristics of LEDS, not all LED bulbs inherently produce a light-distribution profile that satisfies Energy Start criteria. The LED bulbs and techniques described below can be used to produce an LED bulb having a predicted light distribution profile. Specifically, the angle of the LEDs with respect to a central bulb axis may be configured to produce an LED bulb having a light distribution profile that satisfies Energy Star criteria.

### 1. LED Bulb

Various embodiments are described below, relating to LED bulbs. As used herein, an “LED bulb” refers to any light-generating device (e.g., a lamp) in which at least one LED is used to generate the light. Thus, as used herein, an “LED bulb” does not include a light-generating device in which a filament is used to generate the light, such as a conventional incandescent light bulb. It should be recognized that the LED bulb may have various shapes in addition to the bulb-like A-type shape of a conventional incandescent light bulb. For example, the bulb may have a tubular shape, globe shape, or the like. The LED bulb of the present disclosure may further include any type of connector; for example, a screw-in base, a dual-prong connector, a standard two- or three-prong wall outlet plug, bayonet base, Edison Screw base, single-pin base, multiple-pin base, recessed base, flanged base, grooved base, side base, or the like.

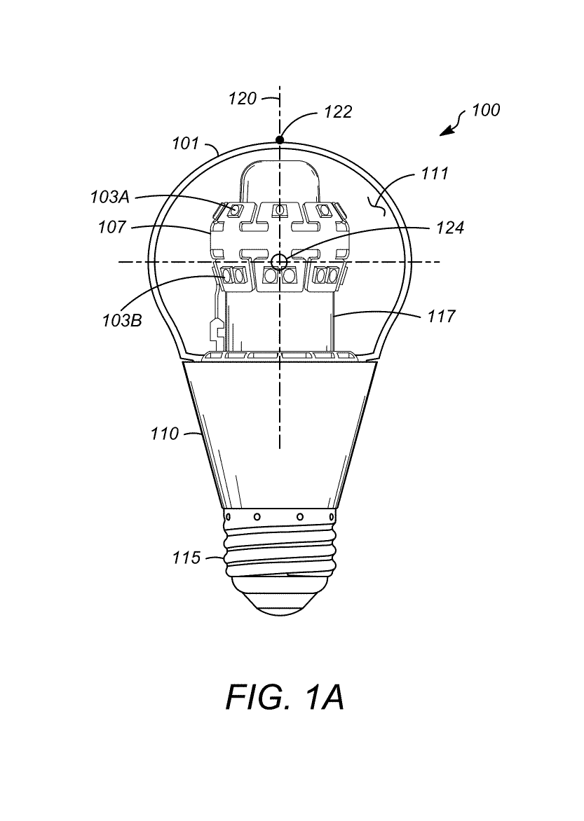

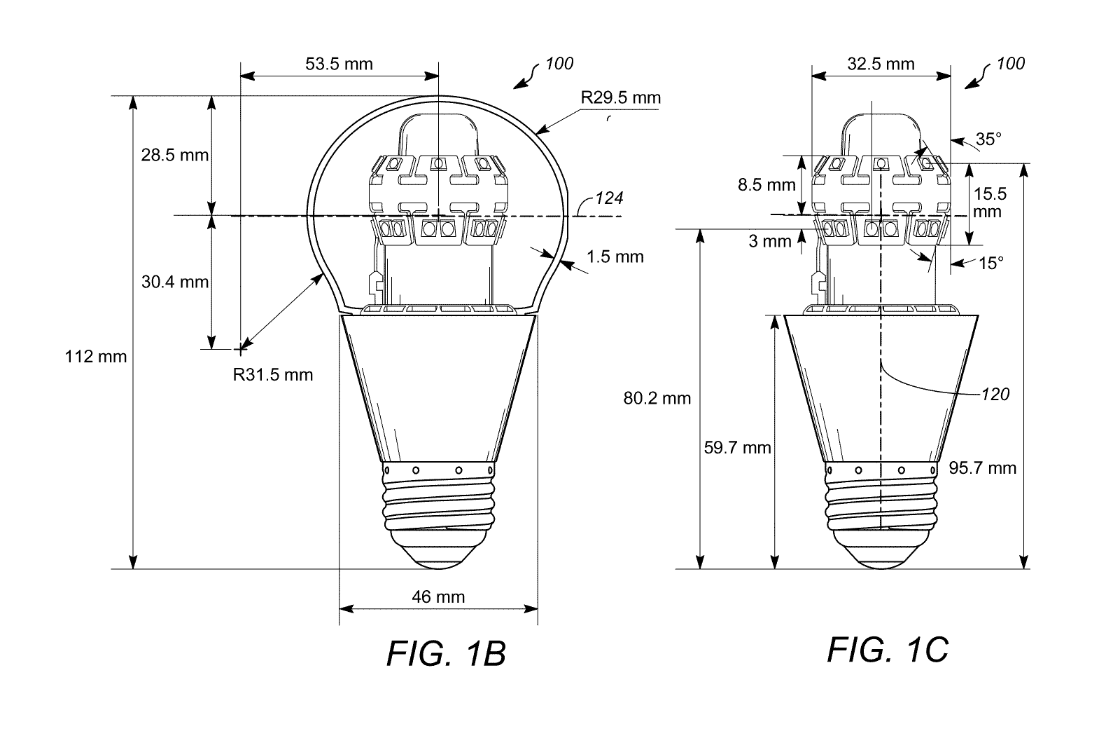

FIG. 1 depicts an exemplary LED bulb 100. The LED bulb 100 includes a base 110 and a shell 101 for encasing the various components of LED bulb 100. The shell 101 is attached to the base 110, forming an enclosed volume 111. An array of LEDs 103A-B is mounted to a support structure 107 and is disposed within the enclosed volume 111. Typically, an air or other gaseous medium fills the enclosed volume 111 between the LEDs 103A-B and the interior of the shell 101.

In this example, the LEDs 103A-B are made from a gallium nitride (GaN) semiconductor material. In addition to emitting light energy in the form of photons, the LEDs 103A-B also produce heat energy that is dissipated to the surrounding environment. Typically, the operating temperature of the LEDs 103A-B should not exceed 120 degrees C. in order to prolong the life of the LEDs 103A-B. Due to these thermal constraints, the LED bulb 100 typically includes one or more components for dissipating the heat generated by LEDs 103A-B. For example, as shown in FIG. 1A, the LEDs are mechanically and thermally coupled to a support structure 107. In this example, the support structure 107 is formed from a composite laminate material that is configured to act as a heat sink and conduct heat energy away from the LEDs 103A-B. The support structure 107 may be made of any thermally conductive material, such as aluminum, copper, brass, magnesium, zinc, or the like.

As shown in FIG. 1A, the support structure 107 is attached to a post 117, which may also be made of any thermally conductive material, such as aluminum, copper, brass, magnesium, zinc, or the like. Heat generated by LEDs 103A-B may be conducted to the post 117 through LED support structures 107. In this way, post 117 may also act as a heat-sink or heat-spreader for LEDs 103A-B. LED support structures 107 and post 117 may be formed as one piece or multiple pieces. In some cases, the post 117 is also thermally connected to the base 110, which may also act as a heat sink.

Base 110 may include one or more components that provide the structural features for mounting bulb shell 101 and post 117. Components of the base 110 may include, for example, sealing gaskets, flanges, rings, adaptors, or the like. The base 110 also typically includes one or more electronic circuits for providing electrical power to the LEDs 103A-B. The one or more electrical circuits may be configured to convert AC power provided by a conventional light socket into DC-power for driving the LEDs 103A-B.

As noted above, light bulbs typically conform to a standard form factor, which allows bulb interchangeability between different lighting fixtures and appliances. Accordingly, in the present exemplary embodiment, LED bulb 100 includes connector base 115 for connecting the bulb to a lighting fixture. In one example, connector base 115 may be a conventional light bulb base having threads for insertion into a conventional light socket. However, as noted above, it should be appreciated that connector base 115 may be any type of connector for mounting LED bulb 100 or coupling to a power source. For example, connector base may provide mounting via a screw-in base, a dual-prong connector, a standard two- or three-prong wall outlet plug, bayonet base, Edison Screw base, single-pin base, multiple-pin base, recessed base, flanged base, grooved base, side base, or the like.

The LED bulb 100 depicted in FIGS. 1A-C is configured to produce a light distribution profile that satisfies uniformity criteria. In this example, the placement of the LEDs 103A-B is configured to provide the LED bulb 100 with a predicted light-distribution profile that varies less than 20 percent in light intensity over 0 degrees to 135 degrees as measured from a centerline axis 120 from the center 124 of the shell through an apex 122 of the shell. More specifically, two sets of LEDs 103A-B are placed at an angle within the enclosed volume to direct light toward the apex 122 and base 110 of the bulb, respectively. One set of LEDs 103A is arranged in a radial pattern around the centerline axis 120 and angled toward the apex 122 of the LED bulb 100. A second set of LEDs 103B is arranged in a radial pattern around the centerline axis 120 and angled toward the base 110 of the LED bulb 100.

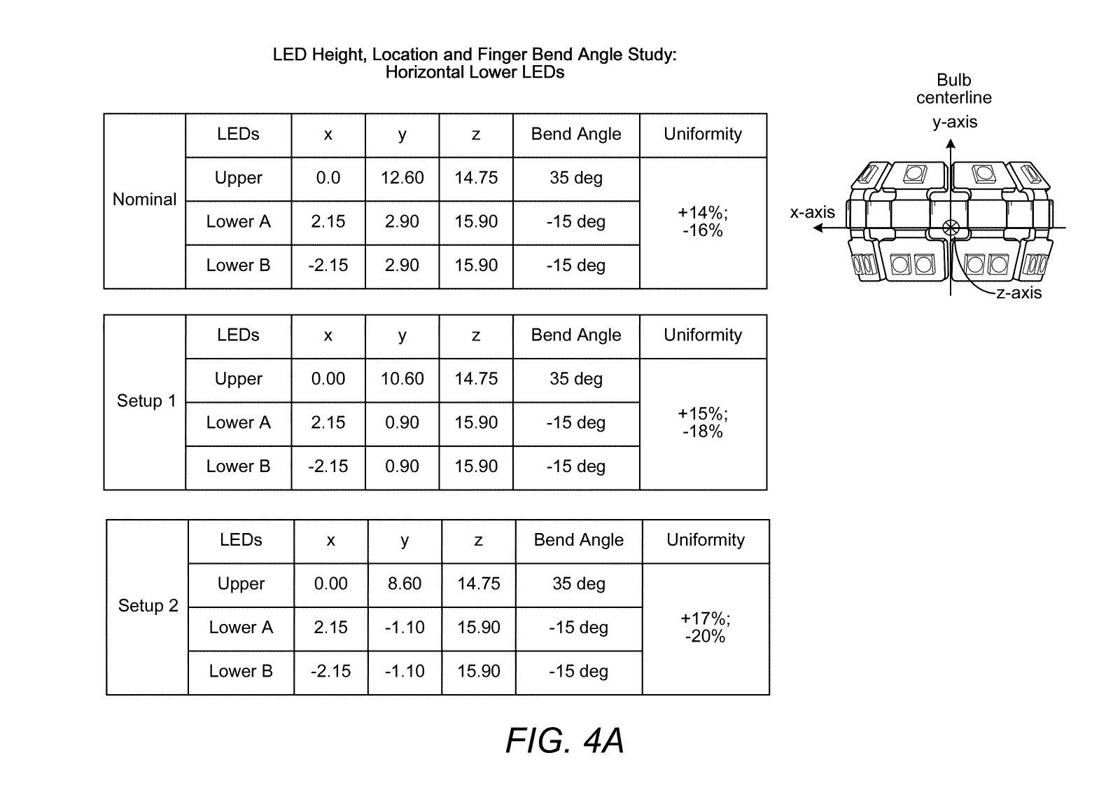

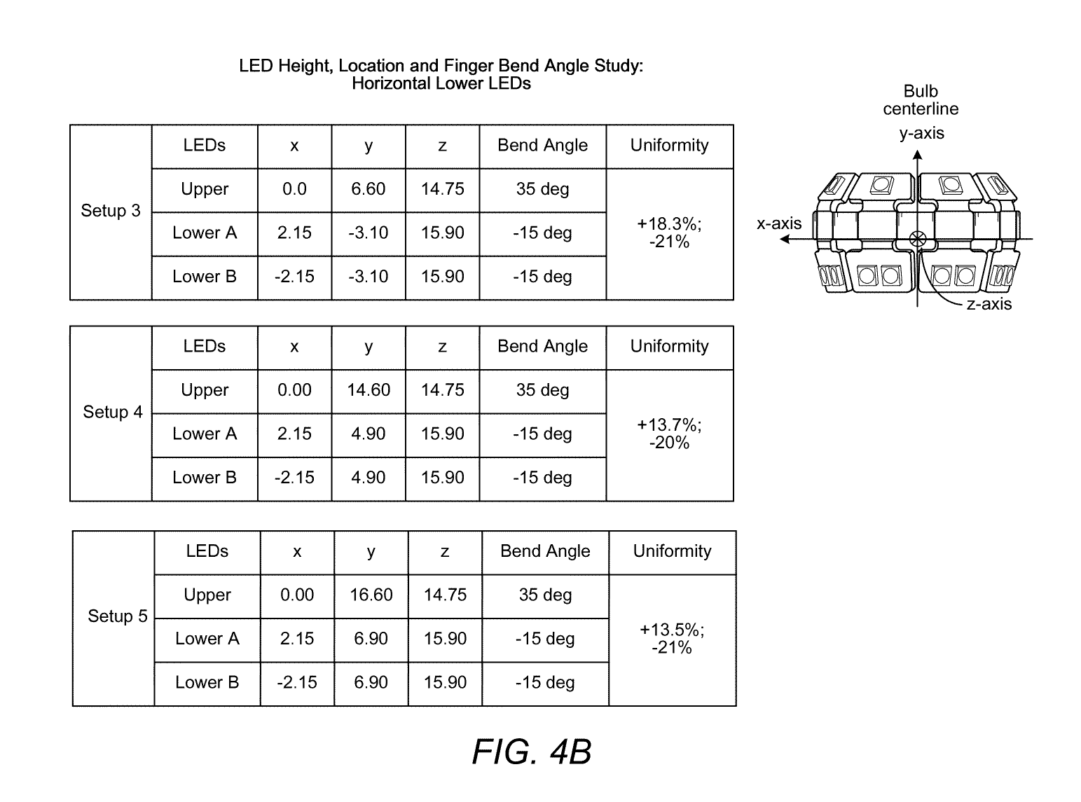

FIGS. 1B-C depict the placement of the LEDs 103A-B with respect to other components of the LED bulb 100. FIGS. 1B-C also depict the dimensions and relative placement of other components in the LED bulb 100 that may or may not affect the uniformity of the light distribution of the LED bulb 100. The dimensions of LED bulb 100 are exemplary in nature and may vary to some degree without significantly changing the uniformity of the light distribution. Examples of other LED bulbs are provided below with respect to FIGS. 4A-B, 5A-C, and 6A-B.

As shown in FIGS. 1B-C, the LED bulb 100 includes 24 LEDs arranged in a radial pattern. A first set of 8 LEDs 103A is attached to an upper portion of the support structure 107 and a second set of 16 LEDs 103B is attached to a lower portion of the support structure 107. The first set of LEDs 103A is positioned at an angle of approximately 35 degrees with respect to the centerline axis 120 of the LED bulb 100. The first set of LEDs 103 is also positioned approximately 8.5 mm above the center 124 of the shell 101. The second set of LEDs 103B is positioned at an angle of approximately −15 degrees with respect to the centerline axis 120 of the LED bulb 100. The second set of LED 103B is also positioned approximately 3 mm below the center 124 the shell 101.

As shown in FIG. 1B, the shell 101 has a constant radius of approximately 29.5 mm for a convex portion of the shell. The shell 101 also has a concave radius of approximately 31.5 mm for the concave portion of the shell (near the stem body of the LED bulb). As shown in FIG. 1B, the center of the concave radius is approximately 30.4 mm below the center 124 and approximately 53.5 mm from the centerline axis 120.

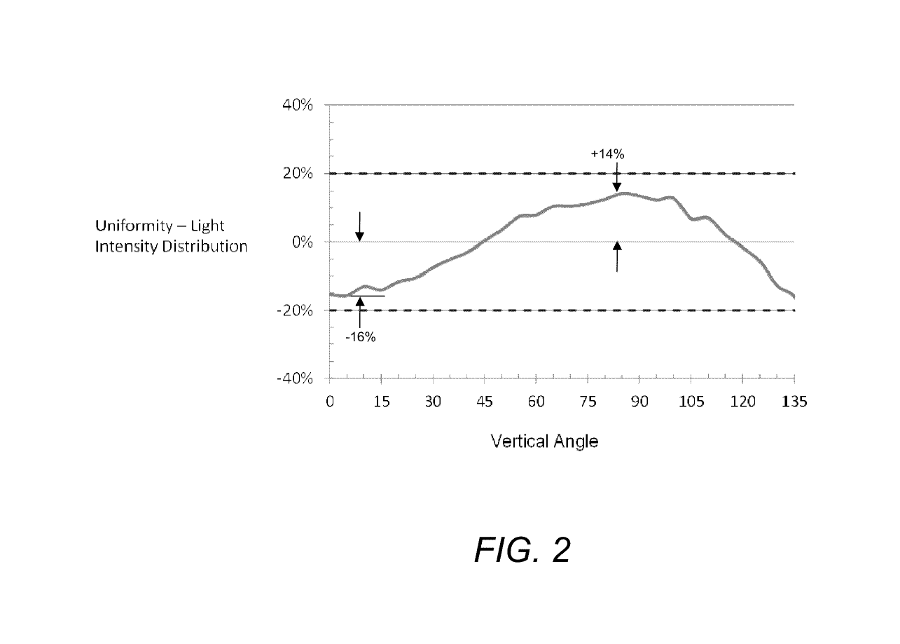

The predicted light-distribution profile for the LED bulb 100 shown in FIGS. 1A-C is shown in FIG. 2. As shown in FIG. 2, the predicted light-distribution profile has a uniformity within +14% and −16% from average intensity between 0 degrees and 135 degrees, as measured from an axis through the center of the LED bulb through the apex of the LED bulb (centerline axis 120). Thus, the LED bulb 100 shown in FIGS. 1A-C may produce a light-distribution profile that satisfies Energy Star uniformity criteria.

The uniformity of the light distribution may also depend on the optical properties of the shell 101. In general, the shell 101 may be made from any transparent or translucent material such as plastic, glass, polycarbonate, or the like. In some cases, it may be desirable to have an LED bulb having a diffuse shell for aesthetic reasons. For example, a diffuse shell hides or masks the internal components of the LED bulb and gives the LED bulb a more uniform “frosted” appearance.

In this example, the shell 101 is made from a plastic material and has diffuse optical properties. In this example, the shell 101 of the LED bulb 100 is made from a diffuse plastic material that diffuses or scatters light that passes through the shell 101. In other implementations, the shell may be made from a clear material having a diffuse coating applied to a surface of the shell.

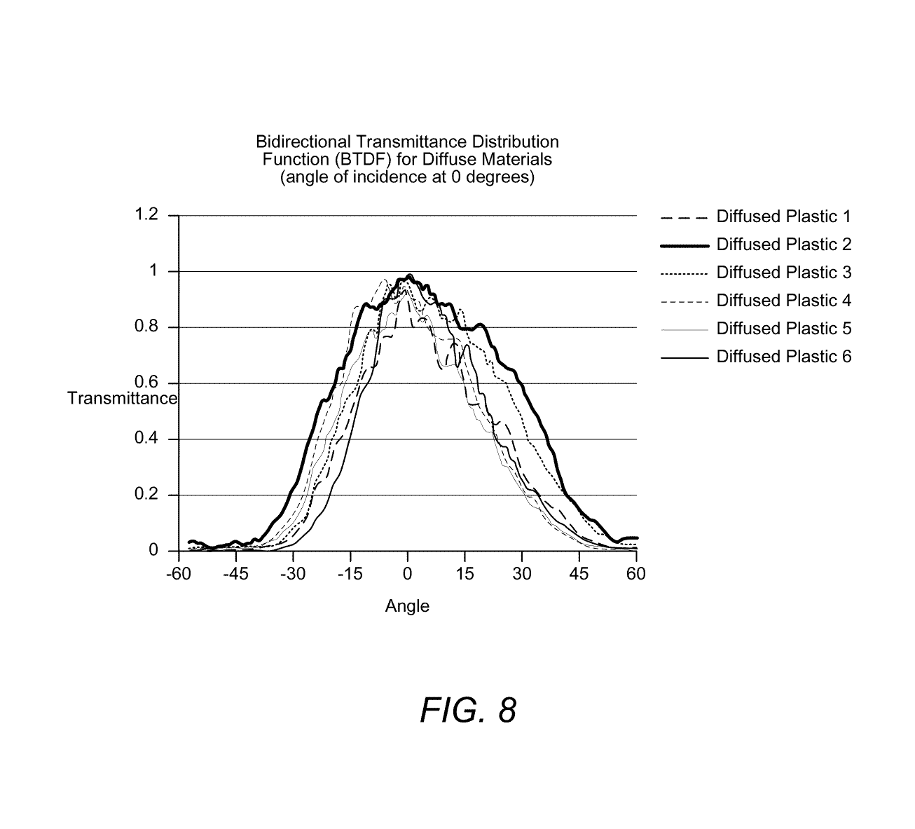

The amount of diffusion for a bulb shell can be quantified with respect to a light-diffusion profile. FIG. 8 depicts the light-diffusion profile of different types of diffusing plastics that can be used for the shell 101. The bi-directional transmittance distribution function (BTDF) represents the amount of light that is transmitted through the plastic as a function of the angle of transmittance (i.e., the angle at which the transmitted light intensity is measured). For the example depicted in FIG. 8, the source light (a laser) has an angle of incidence of 0 degrees, and the resulting light intensity is measured on the other side of the plastic between 0 degrees and 60 degrees to either side (+/−60 degrees). Typically, the light transmittance is highest at an angle of transmittance of roughly 0 degrees (near the angle of incidence) and drops as the angle is swept through +/−60 degrees. Generally, a more diffuse material will scatter more light further from 0 degrees than a less diffuse material. In the examples provided herein, a diffuse shell includes materials having a BTDF that produces more than half of the maximum light intensity at angles greater than 15 degrees from 0 degrees (angle of incidence) and less than 60 degrees from 0 degrees. This is exemplary in nature and in other configurations, a material may be considered diffuse using different criterion.

The LED bulb 100 depicted in FIGS. 1A-C is one example of an LED bulb having an LED placement that is configured to produce distribution of light that satisfies uniformity criteria. More generally, LED bulb 100 serves as an example of how an LED bulb can be configured to produce a uniform light distribution by positioning a first set of LEDs at an angle directed toward the apex of the bulb and a second set of LEDs positioned at an angle toward the base of the bulb.

### 2. Light Distribution Uniformity as a Function of LED Height and Mount Angle

As described in more detail below with respect to other examples, an LED bulb may be configured such that the uniformity of the light distribution is a function of the height and the angle of the LEDs. As demonstrated in the examples of FIGS. 4A-B and 5A-C, these parameters can be optimized to produce an LED bulb having a predicted light-distribution profile that satisfies uniformity criteria. In one example, the optical properties of the shell (e.g., thickness, index of refraction, diffusion), and relevant properties of the other bulb components (e.g., size and shape) are determined or obtained. The positions of the LEDs may then be determined by optimizing the vertical placement (height) of the LEDs with respect to the shell to produce an LED bulb having a predicted light-distribution profile that satisfies uniformity criteria. In another example, the vertical placement of the LEDs, properties of the shell, and relative properties of the LED bulb components are determined or obtained and the angles of the LEDs are optimized to satisfy light-distribution criteria.

In some cases, a computer model of the optical elements of the LED bulb is created. The computer model can be used to optimize one or more of: the properties of the shell, the angle of the LEDs, and the position of the LEDs with respect to the shell.

FIGS. 4A-B and 5A-C depict optical simulation results for multiple LED bulb configurations generated using a computer model. In each of the configurations, the LEDs are arranged into two sets of LEDs: an upper set positioned at an angle toward the apex of the bulb and a lower set positioned at an angle toward the base of the bulb. As described above, the LEDs are typically mounted to a support structure configured to hold the LEDs at a desired position.

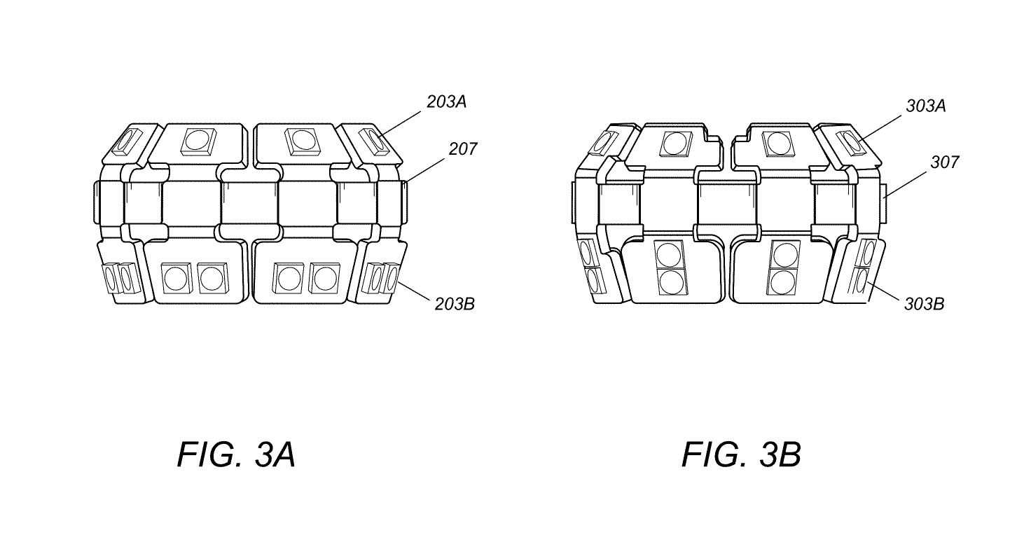

FIGS. 3A and 3B depict two exemplary support structures 207 and 307, respectively. Each of the support structures 207, 307 are formed by cutting a laminate material into a shape having multiple finger protrusions. One or more LEDs are attached to each finger protrusion and the laminate material is formed into a cylindrical shape resulting in the LEDs being arranged in a radial pattern. As shown in FIG. 3A, the laminate structure 207 includes 8 upper fingers and 8 lower fingers. A first set of LEDs 203A is attached to the upper fingers, one LED 203A on each upper finger. A second set of LEDs 203B is attached to the lower fingers, two LEDs 203B on each lower finger. As shown in FIG. 3A, the 203B LEDs on the lower fingers are horizontally aligned. The arrangement depicted in FIG. 3A is used for the optical simulations discussed below with respect to FIGS. 4A-B and 5A-C.

FIG. 3B depicts another exemplary support structure 307. As shown in FIG. 3B, the support structure 307 includes 8 upper finger protrusions for mounting a first set of LEDS 303A, one LED 303A on each finger protrusion. The support structure 307 also includes 8 lower finger protrusions for mounting a second set of LEDs 303B. As shown in FIG. 3B, the second set of LEDs 303B are aligned vertically. The two configurations depicted in FIGS. 3A-B are exemplary in nature and other arrangements of the LEDs may be used.

For purposes of the simulations discussed below with respect to FIGS. 4A-B and 5A-C, the LEDs are assumed to have a Lambertian emission profile with a peak light intensity at an angle approximately perpendicular to the face of the LED for the purposes of modeling the distribution of light. For a shell that is made from plastic, an index of refraction of approximately 1.58 is assumed. For a shell made from glass, an index of refraction of approximately 1.52 is assumed.

For purposes of the simulations, a glass shell having a uniform 1.5 mm thickness was assumed. Also for purposes of the simulation, the other dimensions of the simulated LED bulb are substantially similar to the LED bulb 100, described above with respect to FIGS. 1A-C. The x, y, and z LED locations shown in the table are in millimeters with respect to the center of the convex portion of the shell, as indicated by the axes in the diagram to the right of the tables in FIGS. 4A-B and 5A-C. Specifically, the y-axis is aligned with the LED bulb centerline axis and the x- and z-axes pass through the center of the shell.

FIGS. 4A-B depict the results of multiple simulations that demonstrate the effect of vertical placement of the LEDs on the uniformity of the light distribution. As shown in FIGS. 4A-B, for each of the simulations, the angle of the upper set of LEDs is fixed at 35 degrees and the angle of the lower set of LEDs is fixed at −15 degrees. The vertical position of the LEDs is changed for each simulation configuration, resulting in a different light distribution uniformity for each configuration. As shown in FIGS. 4A-B, the Nominal Setup, Setup 1, Setup 2, and Setup 4 result in a light distribution profile that satisfies Energy Star uniformity criteria. Setups 3 and 5, which represent the two extremes of vertical LED placement, do not result in a light distribution that satisfies Energy Star uniformity criteria. Based on the simulation results depicted in FIGS. 4A-B, a vertical placement for an upper set of LEDs may vary between approximately 15 mm and 9 mm above the center of the shell. The placement for a lower set of LEDs may vary between approximately 5 mm above the center of the shell and 1 mm below the center of the shell. Different LED angles and/or shell geometry may yield different results.

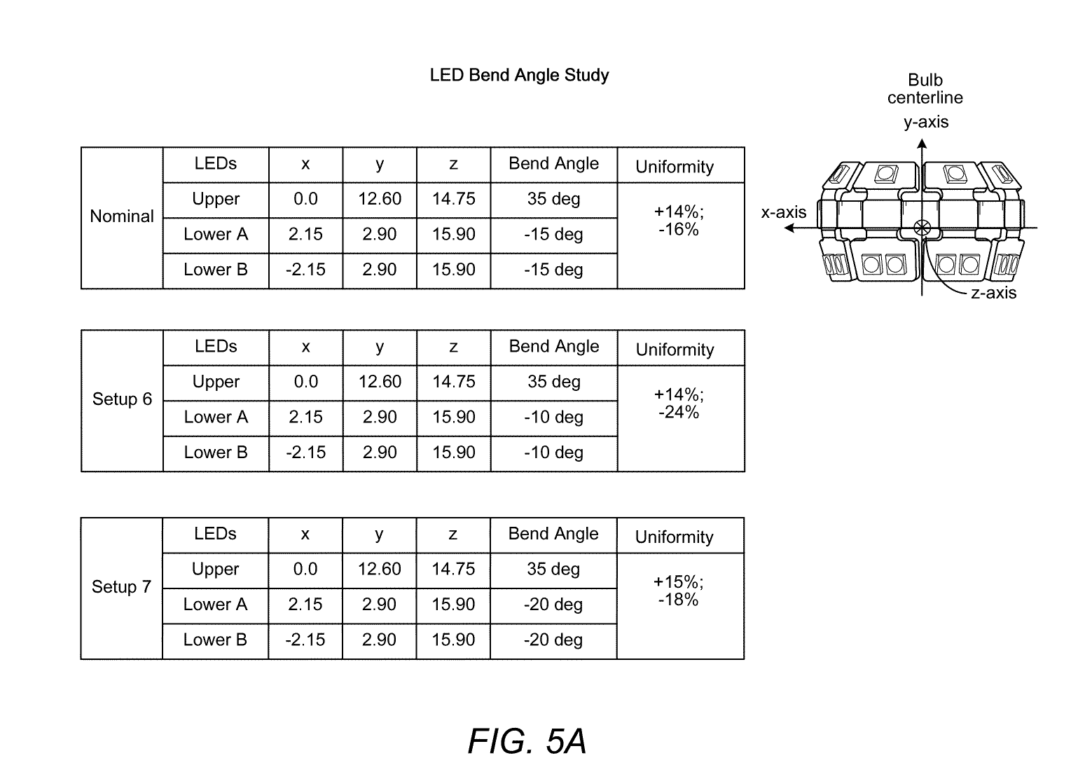

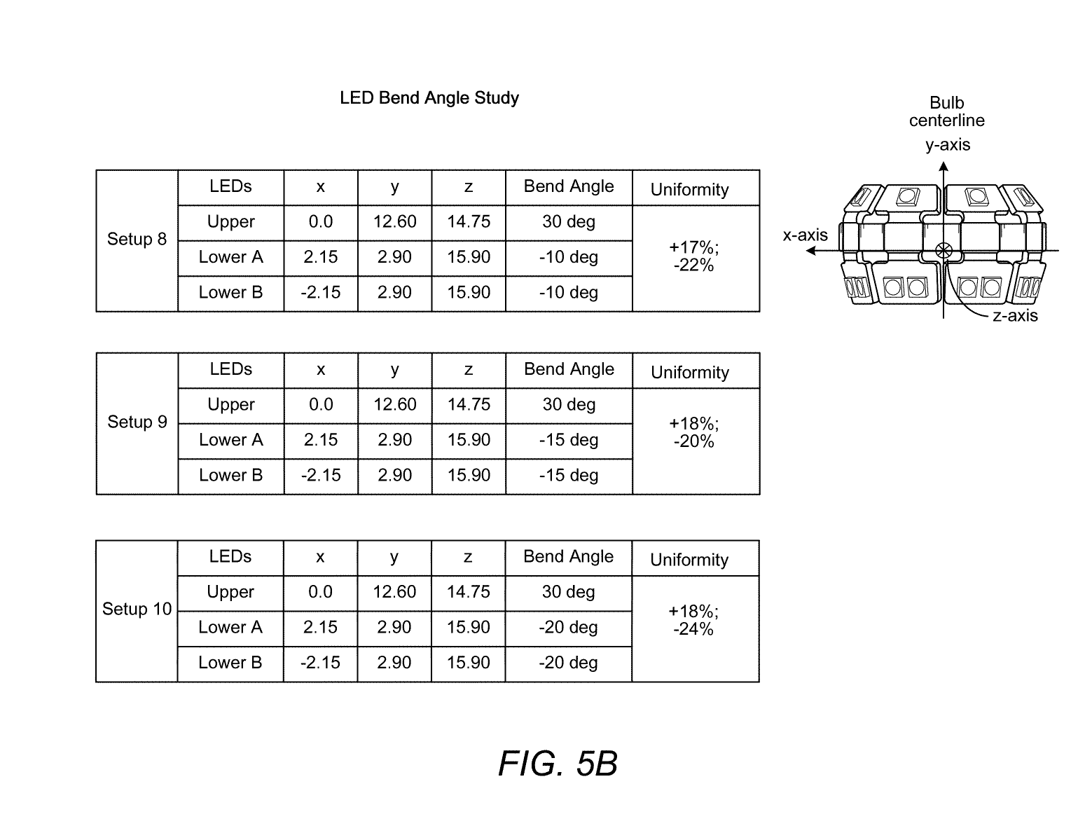

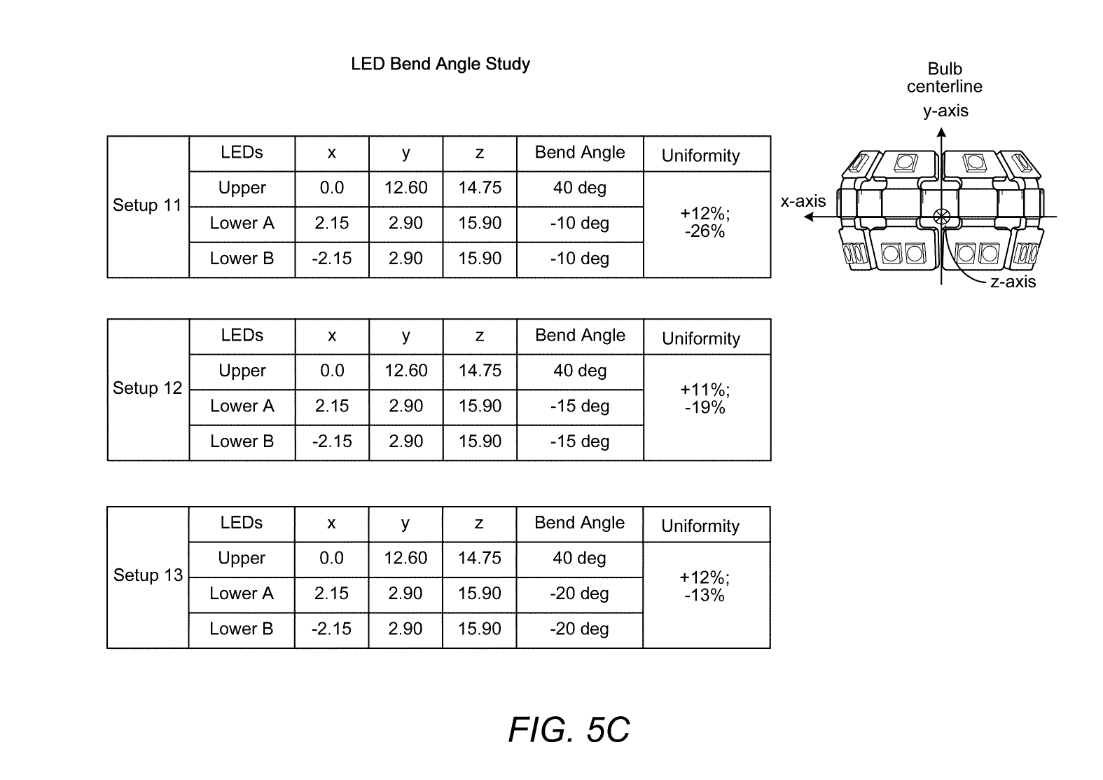

FIGS. 5A-C depict the results of multiple simulations that demonstrate the effect of angle placement of the LEDs on the uniformity of the light distribution. As shown in FIGS. 5A-C, for each of the simulations, the vertical placement of the upper set of LEDs is fixed at 12.6 mm and the vertical placement of the lower set of LEDs is fixed at 2.9 mm. The angle of the LEDs with respect to the centerline axis is changed for each simulation configuration, resulting in a different predicted light distribution uniformity for each configuration. As shown in FIGS. 5A-C, the Nominal Setup, Setup 7, Setup 9, Setup 12, and Setup 13 result in a predicted light distribution profile that satisfies Energy Star uniformity criteria. Setup 6, Setup 8, Setup 10, and Setup 11 do not result in a light distribution that satisfies Energy Star uniformity criteria. Based on the simulation results depicted in FIGS. 5A-C, the angle of an upper set of LEDs may vary between approximately 40 and 30 degrees with respect to a centerline axis of the bulb. The angle of a lower set of LEDs may vary between approximately −15 and −20 degrees with respect to a centerline axis of the bulb. Different vertical placement of the LEDs and/or shell geometry may yield different results.

### 3. LED Bulbs Light-Distribution Profile That Satisfies Uniformity Criteria

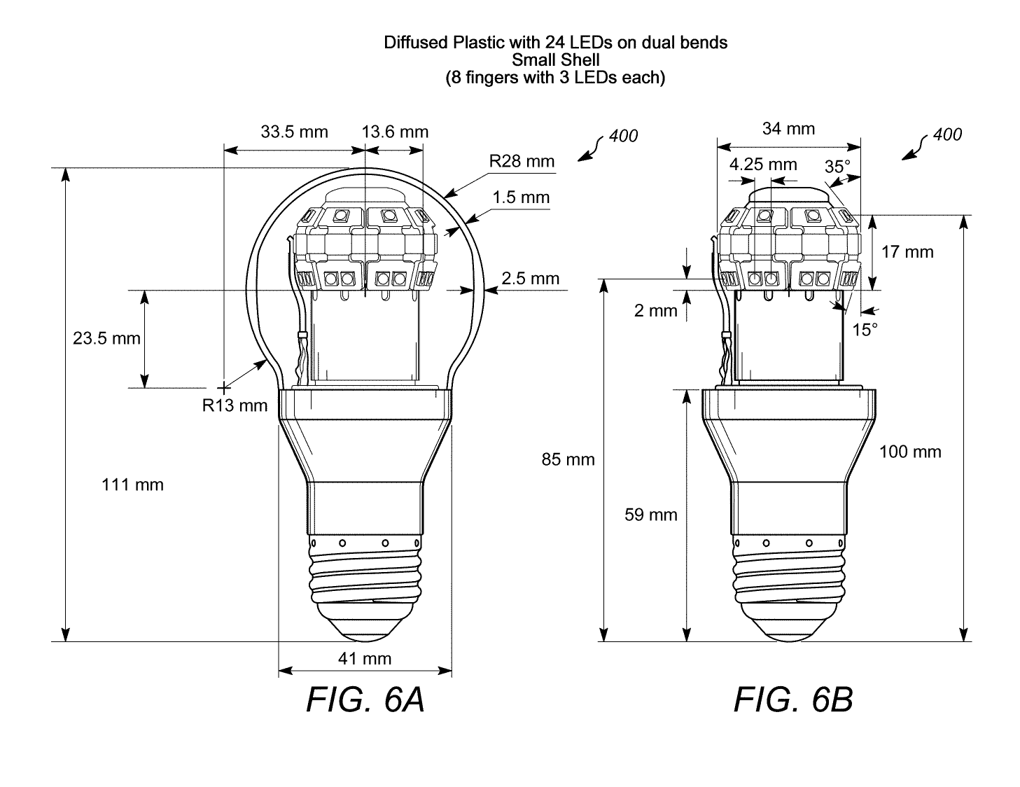

For the LED bulb 400 depicted in FIGS. 6A-B, the vertical position of the LEDs with respect to the shell and the angle of the LEDs with respect to a centerline axis of the bulb are configured to provide the LED bulb with a predicted light-distribution profile that varies less than 20 percent in light intensity over 0 degrees to 135 degrees as measured from an axis from the center of the shell through an apex of the shell. In the examples provided below, the shell has a profile shape with a convex portion and a concave portion, each with a constant radius. In other cases, the shell may have a convex profile shape with a variable radius or another profile shape configured to provide the LED bulb with the desired light-distribution profile.

FIGS. 6A-B depict an LED bulb 400 having a diffused plastic shell and 24 LEDs arranged in a radial pattern. The LEDs are attached to sixteen finger protrusions of a support structure: a set of 8 upper finger protrusions and a set of 8 lower finger protrusions. As shown in FIGS. 6A-B, the set of upper finger protrusions are angled toward the apex of the bulb and the set of lower finger protrusions are angled toward the base of the bulb. As shown in FIG. 6B, the upper finger protrusions are bent at an angle of 35 degrees with respect to the bulb centerline axis and the lower finger protrusions are bent at an angle of −15 degrees with respect to the bulb centerline axis. A first, upper set of 8 LEDs is attached to the upper finger protrusions (one LED per finger protrusion). A second, lower set of 16 LEDs is attached to the lower finger protrusions (two LEDs per finger protrusion, aligned horizontally). The two LEDs on the lower finger protrusions are spaced approximately 4.25 mm apart center-to-center, and approximately 1 mm apart edge-to-edge. The first, upper set of LEDs is positioned approximately 17mm above the center of a convex portion of the shell and the second, lower set of LED is positioned approximately 2 mm above the center of the convex portion of the shell. The LED bulb 400 shown in FIG. 6A includes a shell having a convex radius of approximately 28 mm for the upper, convex portion of the shell. The shell also has a concave radius of approximately 13 mm for the lower, concave portion of the shell (near the stem body of the LED bulb). As shown in FIG. 6A, the center of the concave radius is approximately 23.5 mm below the center of the convex radius and approximately 33.5 mm from the centerline of the bulb.

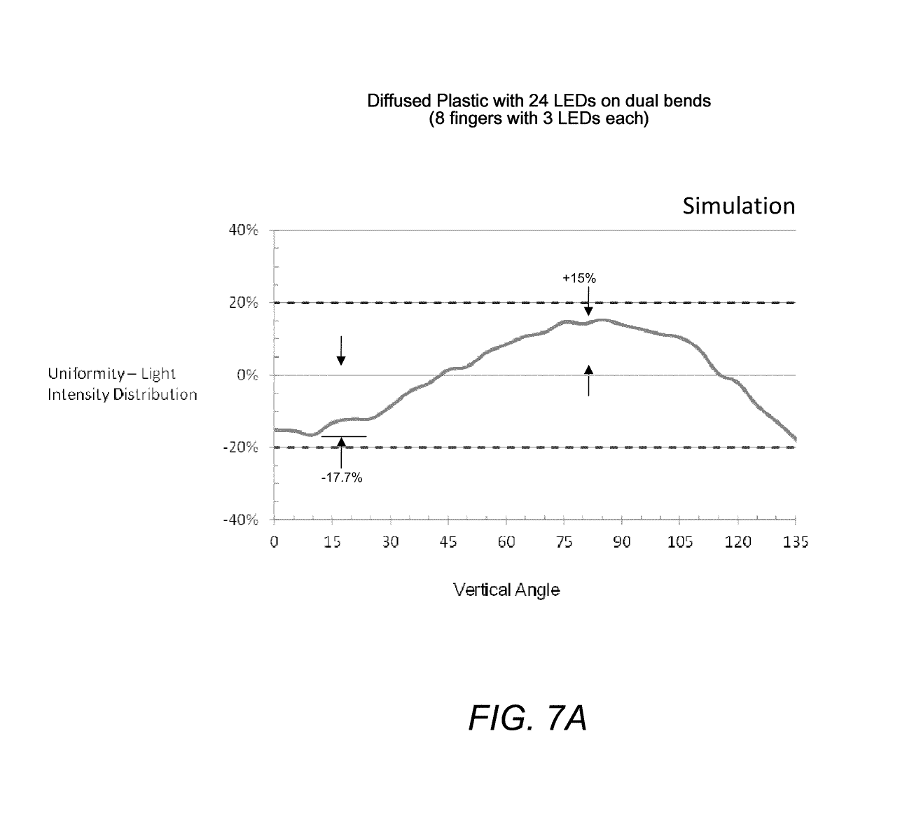

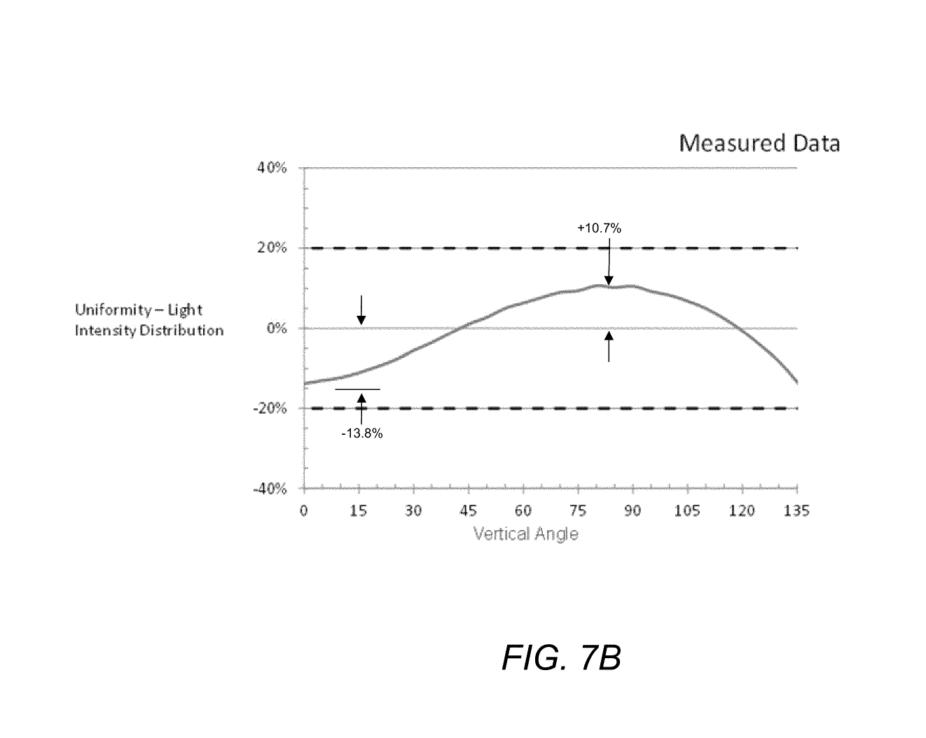

FIG. 7A depicts the predicted light-distribution profile for the LED bulb 400 depicted in FIGS. 6A-B. The predicted light-distribution profile has a uniformity within +15% to −17.7% between 0 degrees and 135 degrees, as measured from an axis through the center of the LED bulb 400 through the apex of the LED bulb 400. Thus, the LED bulb 400 shown in FIGS. 6A-B may produce a light-distribution profile that satisfies Energy Star uniformity criteria.

FIGS. 7A-B also depict the measured light-distribution profile of an actual bulb as compared to the light-distribution profile of a simulated LED bulb having the same configuration. The configuration of these bulbs is described above with respect to FIGS. 6A-B As shown in FIGS. 7A-B, the measured light distribution of the actual LED bulb corresponds to the light distribution predicted by the simulation. The measured data shows a light-distribution uniformity of +10.7% to −13.8% (FIG. 7B), which roughly corresponds to the simulated values of +15% to −17.7% (FIG. 7A).

Although a feature may appear to be described in connection with a particular embodiment, one skilled in the art would recognize that various features of the described embodiments may be combined. Moreover, aspects described in connection with an embodiment may stand alone.

We claim:

1. A light-emitting diode (LED) bulb comprising:
a base;
a shell connected to the base; and
a plurality of LEDs disposed within the shell, wherein:
a first set of LEDs of the plurality of LEDs is positioned a first distance with respect to the center of a convex portion of the shell, and at a first angle with respect to a centerline of the LED bulb,
a second set of LEDs of the plurality of LEDs is positioned a second distance with respect to the center of the convex portion of the shell, and at a second angle with respect to the centerline of the LED bulb, and
the first and second sets of LEDs are configured to provide the LED bulb with a predicted light-distribution profile that varies less than 20 percent in light intensity over 0 degrees to 135 degrees as measured from an axis from the center of the shell through an apex of the shell.

2. The LED bulb of claim 1, wherein the positions of the first and second sets of LEDs with respect to the shell are configured to provide the LED bulb with the predicted light-distribution profile.

3. The LED bulb of claim 1, wherein the first distance, first angle, second distance, and second angle are configured to provide the LED bulb with the predicted light-distribution profile.

4. The LED bulb of claim 1, wherein when the LED bulb is operated, light emitted from the plurality of LEDs passes through a gas medium before passing through the shell.

5. The LED bulb of claim 1, wherein the first distance ranges from 9 mm to 15 mm above the center of the convex portion of the shell and the second distance ranges from 1 mm below to 6.5 mm above the center of the convex portion of the shell.

6. The LED bulb of claim 1, wherein the first angle ranges from 30 degrees to 40 degrees with respect to the centerline of the LED bulb and the second angle ranges from −15 degrees to −20 degrees with respect to the centerline of the LED bulb.

7. The LED bulb of claim 1, wherein the plurality of LEDs are positioned in a radial array around the axis from the center of the shell through an apex of the shell, the radial array having a diameter of approximately 31 mm.

8. The LED bulb of claim 1, wherein the shell is made from a clear material that does not scatter light emitted by the plurality of LEDs.

9. The LED bulb of claim 1, wherein the shell is made from a diffuse material that is configured to scatter light emitted by the plurality of LEDs.

10. The LED bulb of claim 1, wherein the shell includes a diffuse coating that is configured to scatter light emitted by the plurality of LEDs.

11. The LED bulb of claim 1, wherein the diffuse material has a bidirectional transmittance distribution function (BTDF) that, for light that is perpendicularly incident to the surface, results in more than half of the maximum light intensity at angles greater than 15 degrees from the angle of incidence and less than 60 degrees from the angle of incidence.

12. The LED bulb of claim 1, wherein the second set of LEDs of the plurality of LEDs includes multiple pairs of LEDs that are horizontally aligned.

13. The LED bulb of claim 1, wherein the second set of LEDs of the plurality of LEDs includes multiple pairs of LEDs that are vertically aligned.

14. The LED bulb of claim 1, further comprising:
a support structure disposed within the shell, the support structure having a first set of upper finger protrusions and a second set of lower finger protrusions, wherein the first set of LEDs are attached to the first set of upper finger protrusions and the second set of LEDs are attached to the second set of lower finger protrusions.

15. The LED bulb of claim 14, wherein the support structure is made from a sheet of laminate material that is formed into a cylindrical shape.

16. The LED bulb of claim 14, wherein the support structure is made from a sheet of laminate material and is cut into a profile shape to form the first set of upper finger protrusions and the second set of lower finger protrusions, wherein the first set of upper finger protrusions and the second set of lower finger protrusions are bent at an angle and the laminate material is formed into a cylindrical shape.

17. The LED bulb of claim 14, further comprising;
a post disposed within the shell, wherein the post is substantially aligned with a centerline of the LED bulb, and the support structure is attached to the post.

18. A light-emitting diode (LED) bulb comprising:
a base;
a shell connected to the base; and
a plurality of LEDs disposed within the shell;
a gas medium disposed between the plurality of LEDs and the shell, wherein:
a first set of LEDs of the plurality of LEDs is positioned a first distance with respect to the center of a convex portion of the shell, and at a first angle with respect to a centerline of the LED bulb,
a second set of LEDs of the plurality of LEDs is positioned a second distance with respect to the center of the convex portion of the shell, and at a second angle with respect to the centerline of the LED bulb, and
the first and second sets of LEDs are configured to provide the LED bulb with a predicted light-distribution profile that varies less than 20 percent in light intensity over 0 degrees to 135 degrees as measured from an axis from the center of the shell through an apex of the shell.

19. A method of making a light-emitting diode (LED) bulb, the method comprising:
obtaining a base;
connecting a shell to the base; and
placing a plurality of LEDs within the shell, wherein:
a first set of LEDs of the plurality of LEDs is positioned a first distance with respect to the center of a convex portion of the shell, and at a first angle with respect to a centerline of the LED bulb,
a second set of LEDs of the plurality of LEDs is positioned a second distance with respect to the center of the convex portion of the shell, and at a second angle with respect to the centerline of the LED bulb, and
the first and second sets of LEDs and the shell are configured to provide the LED bulb with a predicted light-distribution profile that varies less than 20 percent in light intensity over 0 degrees to 135 degrees as measured from an axis from the center of the shell through an apex of the shell.

20. A method of making a light-emitting diode (LED) bulb having a light-distribution profile that satisfies uniformity criteria, the method comprising:
obtaining a base;
obtaining a shell having an index of refraction;
calculating a first angle and a first distance for a first set of LEDs of a plurality of LEDs based the index of refraction of the shell,
calculating a second angle and a second distance for a second set of LEDs of the plurality of LEDs based the index of refraction of the shell,
wherein the first angle, the first distance, the second angle, and the second distance result in a predicted light-distribution profile that varies less than 20 percent in light intensity over 0 degrees to 135 degrees as measured from an axis from the center of the shell through an apex of the shell;
positioning the first set of LEDs at the first angle and the first distance within the shell;
positioning the second set of LEDs at the second angle and the second distance within the shell; and
attaching the shell to the base.
